(19) United States
(12) Patent Application Publication
(10) Pub. No.: US 2008/0046597 A1
(43) Pub. Date: Feb. 21, 2008

(54) Method for Switching Ip Packets Between Client Networks and Ip Provider Networks by Means of an Access Network

(76) Inventors: Rainer Stademann, Berg (DE); Thomas Theimer, Baierbrunn (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/660,291

(22) PCT Filed: Aug. 11, 2005
(86) PCT No.: PCT/EP05/53964

§ 371 Date: Feb. 15, 2007

(30) Foreign Application Priority Data
Aug. 19, 2004 (EP) 04019739.4

(51) Int. Cl. G06F 15/173; H04L 12/56

(52) U.S. Cl. 709/249; 370/389

(57) ABSTRACT

There is disclosed a method for switching IP packets between client networks and IP provider networks by way of an access network. In a network element of the access network an IP session between a client network and an IP provider network is registered by means of a Layer 2 address assigned to the client network and an IP address assigned to this Layer 2 address. In the network element an IP service connection between the network element and an IP provider network is defined by means of a Layer 2 address assigned to the IP provider network. Further an active IP session is assigned to at least one IP service connection and/or a plurality of active IP sessions are assigned to the same IP service connection. In the network element the switching of the IP packets from active IP sessions to service connections and vice versa is performed by means of the aforementioned assignments.

### CROSS REFERENCE TO RELATED APPLICATIONS

This application is the US National Stage of International Application No. PCT/EP2005/053964, filed Aug. 11, 2005 and claims the benefit thereof. The International Application claims the benefits of European application No. 04019739.4 EP filed Aug. 19, 2004, both of the applications are incorporated by reference herein in their entirety.

### FIELD OF INVENTION

The invention relates to access networks for broadband user connection. Further to a Method for switching IP packets between client networks and IP provider networks by way of an access network.

### BACKGROUND OF INVENTION

While the network architecture for ATM-based access networks has already been defined in the DSL Forum, work relating to IP- and Ethernet-based access networks is still in the initial stages.

The architecture for ATM-based broadband access networks with QoS support is described for example in the DSL Forum specifications TR-058 and TR-059. These networks are based on permanently established ATM virtual connections (PVC) between the user connection and a central IP network-access node (Broadband Access Server, BAS). The BAS (Broadband Access Server) performs the access control and authentication of the users and also service selection.

An object of the invention is to improve the transportation of IP packets between a client router and an IP network service provider.

### SUMMARY OF INVENTION

Future access networks for broadband user connection must provide higher bandwidths at lower costs than is possible with the ATM-based connection networks common today. For this reason, the aim is to base future networks more heavily on IP and Ethernet technology which is currently establishing itself in the market as an attractive solution for metro networks.

While the network architecture for ATM-based access networks has already been defined in the DSL Forum, work relating to IP- and Ethernet-based access networks is still in the initial stages. What is required is a new network architecture for the IP- and Ethernet-based aggregation of broadband user connections which satisfies the following requirements in an optimum fashion:
Dynamic network access with authentication and access control
Minimal administrative overhead for setting up new users
Good scalability
Traffic separation between individual user connections
Dynamic selection of different services or service classes
Dynamic selection of different service providers
Aggregation of many users into a small number of service-specific logical tunnels
Support for—Quality of Service
High resistance to various forms of attack on the network functions and integrity

This invention relates to a new type of aggregation solution for use particularly in Ethernet-oriented broadband access networks. The aim of the invention is to enable simultaneous IP sessions by an end client using an Ethernet access network to a plurality of different IP networks of independent IP service providers without requiring PPPoE for this. Independent IP network service providers are not required to coordinate their IP address spaces with one another; the address spaces of different IP network service providers can also overlap or be identical. The intention of the invention is to make it possible to establish cost-effective networks using IP over Ethernet and a DHCP based Session Control while a plurality of independent IP network service providers can be simultaneously supported through an access network.

The object of the invention is achieved by a method for switching the data packets using the data assigned to an IP session. Specifically this means:
For packets in the direction from the client network to an IP network service provider: received packets are assigned to an IP session (in the example: M1 and Ia1) on the basis of their source Layer 2 address and source IP address. All the packets of an IP session are forwarded to the Layer 2 address assigned to the session of the IP network service provider (in the example: M7).
For packets in the direction from an IP network service provider to the client network: received packets are assigned to an IP session (in the example: M7, Ia1) on the basis of their source Layer 2 address and destination IP address. All the packets of an IP session are forwarded to the Layer 2 address assigned to the session of the client network (in the example: M1).

In addition to the stated object of the invention, in many networks there results a further related object which is also referred to in the following as an additional object.

For business clients, network service providers often offer global network services on Layer 2. Examples are ATM services (e.g. Permanent Virtual Circuit (PVC) services), TDM Leased Line Services (e.g. E1/T1 services) and recently Metro Ethernet services, as specified for example by the Metro Ethernet Forum (MEF). With regard to these services, Layer 2 frames or cells of the protocols in question are generally transported unchanged between the handover points of the business client through the network of the service provider.

For private clients, these Layer 2 based services are often not necessary because with private clients it is usually a case of Internet access services or access services to applications based on the IP protocol such as for example VoIP or to video applications. These applications require the transportation of IP packets of the private client to one or more IP network service providers, and where applicable also simultaneous access to a plurality of IP network service providers. For these services, the transportation of IP packets between the client network and the IP network service providers in question is sufficient. Although a Layer 2 based service is adequate for this purpose, it is not however required. Since both scaling problems (only 4096 VLAN tags, for example) and also various security risks are associated particularly with the use of Ethernet as Layer 2 (for example MAC address spoofing, MAC address flooding), it is advantageous particularly for private clients to terminate the Layer 2 in the access node and to transport the IP packets themselves to the IP network service provider. Solutions which do not transport the complete Ethernet frames from the client network to the IP network service provider but only their Layer 3 content, namely the IP packet, are thus particularly advantageous.

Above stated objects can be solved in different ways:

a) The architecture for ATM-based broadband access networks with QoS support is described for example in the DSL Forum specifications TR-058 and TR-059. These networks are based on permanently established ATM virtual connections (PVC) between the user connection and a central IP network-access node (Broadband Access Server, BAS). The BAS (Broadband Access Server) performs the access control and authentication of the users and also service selection. This architecture has various disadvantages:
The connections (PVC) between user and BAS must be configured both in the ATM network and also in the BAS.
A separate ATM PVC is required for each QoS class.
The traffic between users must always pass via the BAS.
Today's BAS products do not allow any cost-effective services with high data rates (a plurality of video channels per user, for example)

b) One method which partially neutralizes the security problem for Ethernet access networks has been disclosed in the IETF Draft draft-melsen-mac-forced-fwd-02.txt under the title “MAC Forced Forwarding: An ARP proxy method for ensuring traffic separation between hosts sharing an Ethernet Access Network” by T. Melsen and S. Blake. With regard to this method, the access node checks the MAC destination address used on the user side in the Ethernet frames for validity. An ARP proxy in the access node additionally returns only valid MAC addresses in the case of user-side ARP requests. This method does not solve the problem of simultaneous access to different independent IP networks.

c) Another method has the name “(Virtual) MAC Address Translation”. (See for example ITU Contribution COM 13-D 447-E from the ZTE Corporation, dated February 2004). With this approach, the MAC addresses of the user-side Layer 2 end points are converted by the access node reversibly unambiguously into “virtual” MAC addresses which the access network service provider determines. The MAC addresses of the network-side Layer 2 end points remain unchanged when the Ethernet frames pass through the access node. The particular disadvantage of this approach to a solution is the fact that an additional virtual MAC address is required in the network for each user-side MAC address. This method also fails to solve the problem of simultaneous access to different independent IP networks.

d) In a further method, an IP router function in the access node terminates the Layer 2 and routes the IP packets of Layer 3 on the basis of the IP addresses (IP routing). The following disadvantages result with this solution:
i. The access network service provider must itself be an IP network service provider.
ii. The IP addresses cannot be allocated by independent IP network service providers.
iii. The number of IP routers is increased by about one to two orders of magnitude when compared with today's IP networks, as a result of which the costs for operating the IP network rise considerably.
iv. The IP router must be capable of handling complex routing protocols.

e) A further solution uses the PPPoE or PPPoA protocol between client network and IP network service provider. In this case, PPP tunnels to the relevant IP network are set up, in which the IP packets are transported. The disadvantages associated with this solution are the high costs for terminating PPPoE/PPPoA in a broadband access server (BAS) as well as security problems in Ethernet based access networks.

### BRIEF DESCRIPTION OF THE DRAWING

FIG. 1 shows an example of a network scenario.

FIG. 2 schematically illustrates the mode of functioning of an access node.

FIG. 3 shows a tabular where end-client-side IP sessions are assigned to network-side IP service connections.

FIG. 4 shows how the switching specifications from FIG. 3 are used by a network element in order to convert the Layer 2 addresses.

FIG. 5 shows how IEEE Standard 802.1x can be used in order to determine a first part of the switching specification.

FIG. 6 shows how a service profile can be used in the IP service switch in order to perform policing of the traffic specifically for the IP session in question.

FIG. 7 shows for the case of IPv4 how DHCP messages are used in order to establish an IP session.

FIG. 8 shows how the IP service switch initiates the IP session after expiry of the lease time.

FIG. 9 shows how, in the case of IPv4. ARP requests from the user 801 or ARP requests from the IP edge router 803 are replied to by the IP service switch.

FIG. 10 shows the structure of the IP address for the special case of IPv6.

### DETAILED DESCRIPTION OF INVENTION

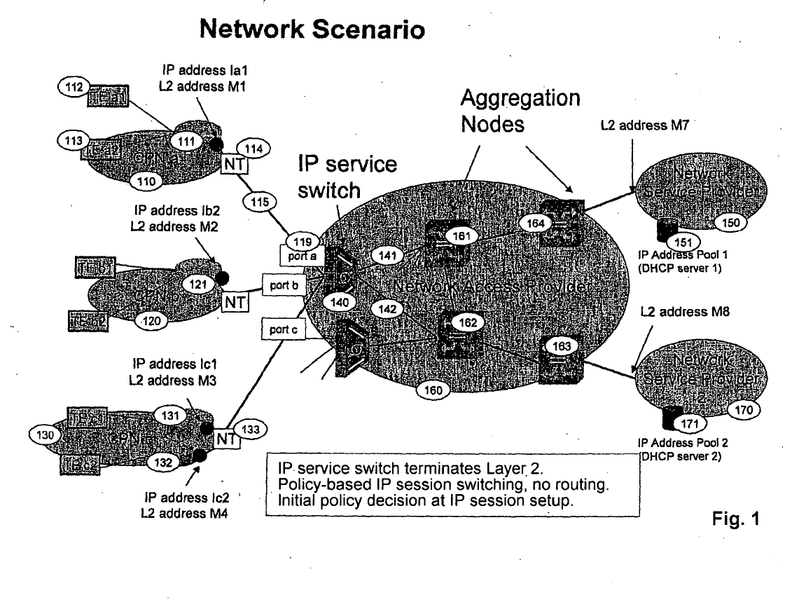

An example of a network scenario in which this invention can be used to great advantage is shown in FIG. 1. This scenario contains three client networks 110, 120, 130. By way of example, let us first consider the client network 110. The client network 110 contains two terminal devices (PCs for example) 112 and 113. These are connected to a client IP router 111. The router 111 is connected to a network terminator (NT) 114. The network terminator 114 is connected by way of an access line 115 to the “port a”, 119, of the access node 140. The access node is connected by way of two uplinks 141 and 142 to two aggregation nodes 161 and 162. Finally, two IP networks 150 and 170 of two IP network service providers are accessible by way of further optional aggregation nodes 163 and 164. Access nodes and aggregation nodes belong to the access network 160 of an access network service provider.

In the example, the task consists in transporting IP packets between client router 111 and the IP network service provider 150 by way of the access network for the duration of an IP session, to which end the network service provider must first assign an IP address (Ia1 in the example) to the client router. To this end the network service provider 150 must use known protocols, such as DHCP for example, and further tools, such as a DHCP server 151 for example.

Accordingly, in the example the network service provider 170 must be able to assign an IP address b2 to the client router 121 in the client network 120 similarly for the duration of an IP session, and IP packets must be transported by way of the access network 160 between the client router 121 and the network service provider 170. In this situation, it must be possible to allocate the IP addresses Ia1 and Ib2 totally independently of one another.

It must also be possible for a plurality of IP addresses to be simultaneously assigned to a client network by different IP network service providers. An example is shown for the client network 130. This contains two client routers 131 and 132 which are both connected for example by way of an Ethernet network to the same network terminator 133. Here, the IP network service provider 150 must be able to assign an IP address Ic1 to the router 131 while the IP network service provider 170 must be able to simultaneously assign an IP address Ic2 to the second router 132 in the same client network. It must be possible to transport IP packets simultaneously by way of the access network 160 on the one hand between router 131 and IP network service provider 150 and on the other hand between router 132 and IP network service provider 170.

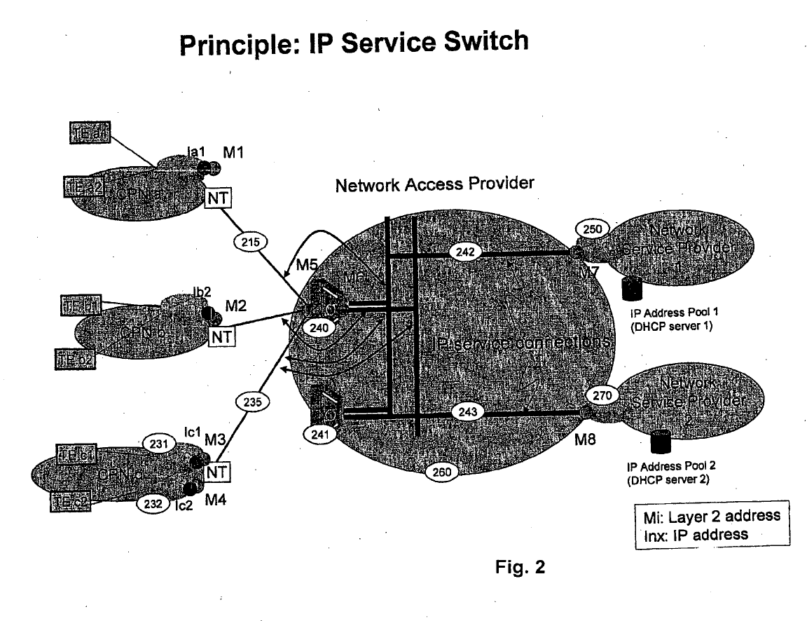

FIG. 2 schematically illustrates as one embodiment of the invention the mode of functioning of an access node which is operating according to the invention as an IP service switch. In the access network 260, for each supported IP network service provider one or more “IP service connections” are implemented between one or more access nodes and one or more IP edge routers of the IP network service provider. In the example shown in FIG. 2, an IP service connection 242 is set up between the access nodes 240 and 241 and the edge router 250 for network service provider 1. Correspondingly, a further IP service connection 243 is set up between the same access nodes 240 and 241 and the IP edge node 270.

In the simplest case, IP service connections are given only by a Layer 2 destination address of the interface in the access network to an IP edge router of the relevant IP network service provider. In the example shown in FIG. 2, these are the Layer 2 addresses M7 and M8. In Ethernet networks, M7 and M8 are the MAC addresses of the Ethernet interface in the edge routers 250 and 251. Characteristic of an IP service connection within the meaning of this invention is the transportation of IP packets between one or more IP service switches one the one hand and one or more edge routers on the other hand, which can be reached through Layer 2 addresses from the network element (IP service switch) according to the invention (the IP service switch itself does not require a separate IP address for this purpose). As the IP service connections are thus defined on Layer 2, the IP addresses of the transported IP packets between different IP service connections can be chosen independently of one another.

For reasons of security and in order to be able to more simply guarantee specific qualities of service in the access network, it is often advantageous to employ additional Layer 2 attributes in order to implement IP service connections. In Ethernet networks, the VLAN technology as per IEEE Standard 802.1q can advantageously be used for this purpose, for example. To this end, the IP service switch 240 in the example shown in FIGS. 2, 3, 4 sets up the VLAN tag 2011 or 2022 of the IP service connection in addition to the destination MAC address M7 or M8 respectively. This is advantageous because resources of the access network can only be assigned to an IP service connection by this means in the following L2 switches of the access network provider on the basis of the VLAN tag. This is a function commonly found in many Layer 2 switches. Implementations of IP service connections through MPLS (Label Switched Path) or IP technology (L2TP, RFC 2661 for example) are also conceivable.

In addition, FIG. 2 shows how the access node switches IP packets between IP sessions of the client-side ports on the one hand and the IP service connections on the other hand. For example, incoming IP packets from the IP session on access line 215 (corresponding to port a in FIG. 1) are switched onto IP service connection 242 and, conversely, incoming IP packets on the IP service connection 242 with IP address Ia1 are switched to the IP session of access line 215.

In the example of the access line 235 it is assumed that IP packets of the two different IP sessions are transported between the client routers 231 and 232 on the one hand and the access node 240 on the other hand for example by way of an Ethernet VLAN, different in each case, (“1001” and “1002” for example) in accordance with IEEE Standard 802.1q or for example by way of different ATM PVCs. Incoming IP packets in Layer 2 frames from access line 235 with source Layer 2 address M3 and out of VLAN “1001” belong to one IP session and are switched onto IP service connection 242 and incoming IP packets from access line 235 with source Layer 2 address M4 and out of VLAN “1002” are switched onto IP service connection 243. Conversely, incoming IP packets from the access node on IP service connection 242 with IP address Ic1 are packed in Layer 2 frames with VLAN “1001” and destination Layer 2 address M3 and switched onto the access line 235. Incoming IP packets on IP service connection 243 with IP address Ic2 are switched to the access line 235 in Layer 2 frames with VLAN “1002” and destination Layer 2 address M4.

Characteristic of an IP session within the meaning of this invention are
a) at least one Layer 2 address with which a device in a client network can be accessed, and
b) at least one IP address assigned to this aforementioned Layer 2 address.

In most cases it is advantageous for the purposes of identifying an IP session to additionally add one or more physical ports of the network element according to the invention by way of which the aforementioned device can be accessed in the aforementioned client network. By way of example, different devices can thus use the same Layer 2 addresses if these are accessible by way of different physical ports.

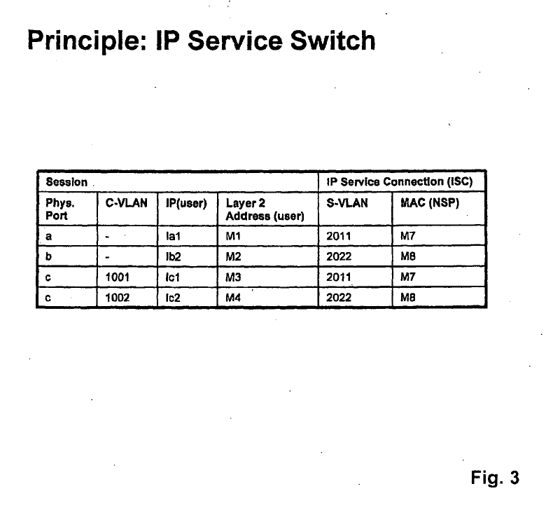

The specifications relating to the session-based IP switching can be held in tabular form by the access node. An example is shown in FIG. 3. In this table, end-client-side IP sessions are assigned to network-side IP service connections.

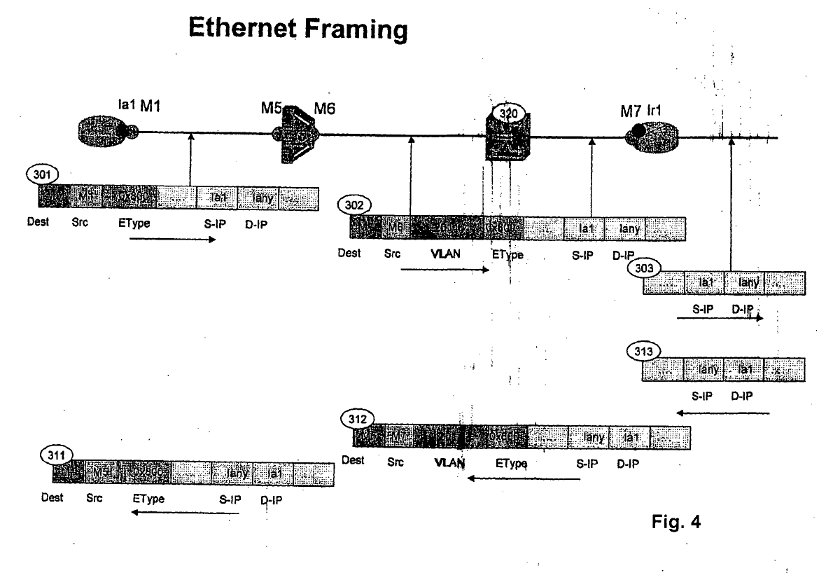

IP sessions are defined in the example by a client-side physical port on the IP service switch (in the example a, b, or c) and by a client-side Layer 2 address and the assigned IP address. In addition, further attributes can define an IP session. These include, for example, a client-side VLAN tag (in FIG. 4, under the table column “C-VLAN”).

IP-service connections are defined in the example by a network-side Layer 2 address of the end point of the IP service connection. In the example shown in FIG. 3 these are the addresses M7 and M8 of the end points on the IP edge routers 151 and 171 of the two IP network service providers 150 and 170. Optionally, further attributes can characterize a service connection. In the example of the switching specification given in FIG. 3, a VLAN tag (in FIG. 4, under the table column “S-VLAN”) in accordance with IEEE 802.1q is assigned to a service connection in each case.

With the aid of the switching specifications predefined by the table in FIG. 3, the necessary address and attribute conversions can be performed by the IP service switch. Apart from these conversions, additional checks on the traffic can take place in order to ensure the network security and integrity, for example. By way of example, IP packets of an end client can be discarded if they no not bear the source IP address predefined in a switching specification. The switching specifications can be predefined administratively either in their entirety or in part or they are learned automatically in the access node when an IP session is set up through the processing of protocols for authentication, authorization and IP address assignment such as 802.1x, DHCP, RADIUS.

In an advantageous embodiment of the invention, FIG. 4 shows in the situation where Ethernet is the Layer 2 protocol how the switching specifications from FIG. 3 are used by a network element in order to convert the Layer 2 addresses and attributes of the Ethernet frames when the packets are switched between IP session and IP service connection.

In contrast to the known approach to a solution 1d), in this advantageous embodiment of the method according to the invention different user-side MAC addresses M1 to M4 can be mapped to the same network address M6. In the example shown in FIG. 4, the source address M1 in frame 301 is replaced by the MAC address M6 in frame 302 in the IP service switch. At the same time, the destination address M5 is replaced by the destination address M7 of the edge router 250 in the IP service switch. Conversely, in the example shown in FIG. 3, in the reverse direction (frames 311,312,313) the source address M7 in frame 312 is replaced by the source address M5 of the IP service switch before the frame is sent to the client router 111. Accordingly, the destination address M6 in frame 312 is replaced by the address M1 of the client router 111.

The scalability is increased as a result because the access network does not need to learn the user-side MAC addresses M1 to M4. At the same time, attacks on the access network such as “MAC address flooding” are averted. In the reverse direction, the network-side MAC addresses M7 and M8 of the edge routers 250 and 270 are not forwarded to the users but are replaced by a MAC address M5 of the IP service switch. The network security is also increased by this means because the addresses of the edge routers hereby remain hidden from the users.

It is also advantageous if a VLAN tag (in the example shown in FIG. 4 the VLAN tag “2011”) is applied in the IP service switch 240 in the direction of the network as an additional attribute of the IP service connection. By means of this VLAN tag, it is possible to reserve resources such as for example bandwidth on a connection line in a subsequent Layer 2 switch. In the direction of the end client the VLAN tag “2011” is removed by the IP service switch. Other implementations of IP service connections using MPLS paths for example (LSP, Labeled Switched Path) are possible and are only variations of this invention.

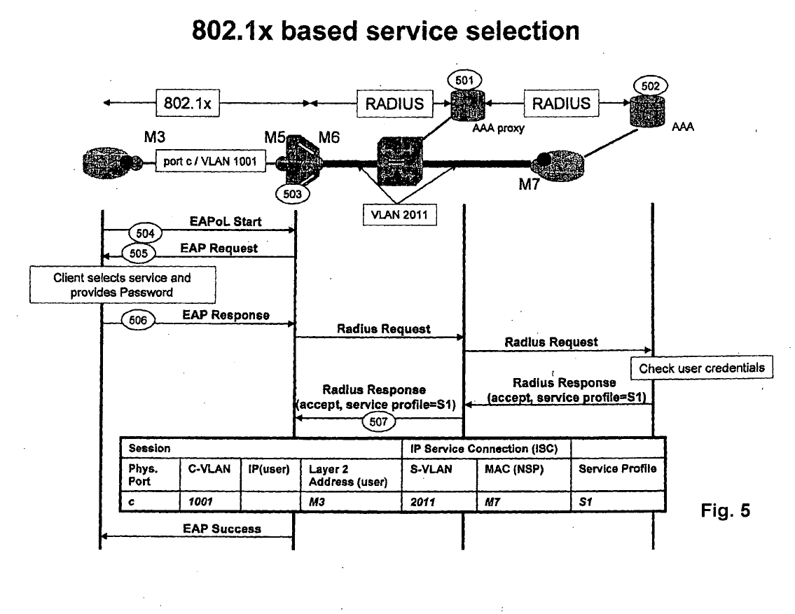

In a further advantageous embodiment, FIG. 5 shows how IEEE Standard 802.1x can be used in order to determine a first part of the switching specification. The user is first authenticated and authorized according to the prior art by using the protocols 802.1x and RADIUS, as well as an AAA (Authentication, Authorization, Accounting) database. In this situation, the user can for example specify the desired service and IP network service provider by specifying a fully qualified domain name (FQDN). By means of the FQDN, the RADIUS request is passed on by the proxy 501 to the AAA server 502 of the IP network service provider. The latter checks the credentials (password, for example) and, if successful, returns a RADIUS message which contains information about the requested service (service profile). By means of this information the IP service switch 503 can determine the associated IP service connection which is given in the example by the Layer 2 address M7 and the S-VLAN “2011”. Physical port (c), C-VLAN (1001) and Layer 2 address of the end-client device are derived from the 802.1x frames 504, 505 and 506 by the IP service switch.

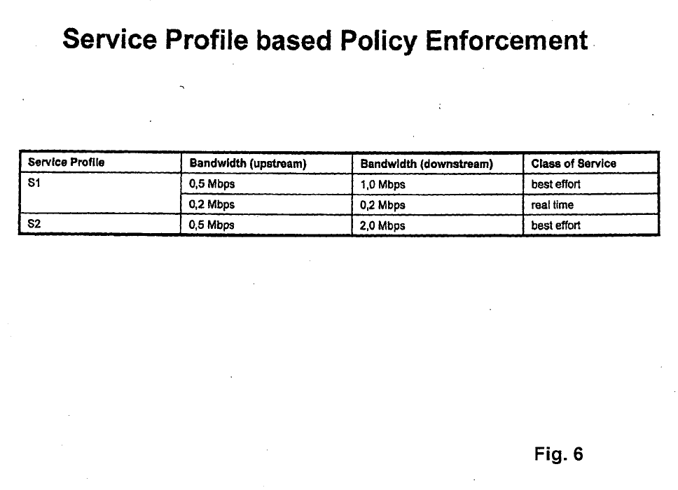

FIG. 6 shows how a service profile (in the example shown in FIG. 5 the service profile S1 from the message 507) can be used in the IP service switch in order to perform policing of the traffic specifically for the IP session in question. To this end, the IP service switch contains for example a table as shown in FIG. 6, in which various service profiles are defined. Thus, profile S1 defines an IP service with a “best effort” and a “real time” class of service, whereby in each case the specified maximum bandwidths are released by the IP service switch for an IP session with profile S1. Accordingly, S2 defines a profile with only a “best effort” class of service with the specified maximum bandwidths.

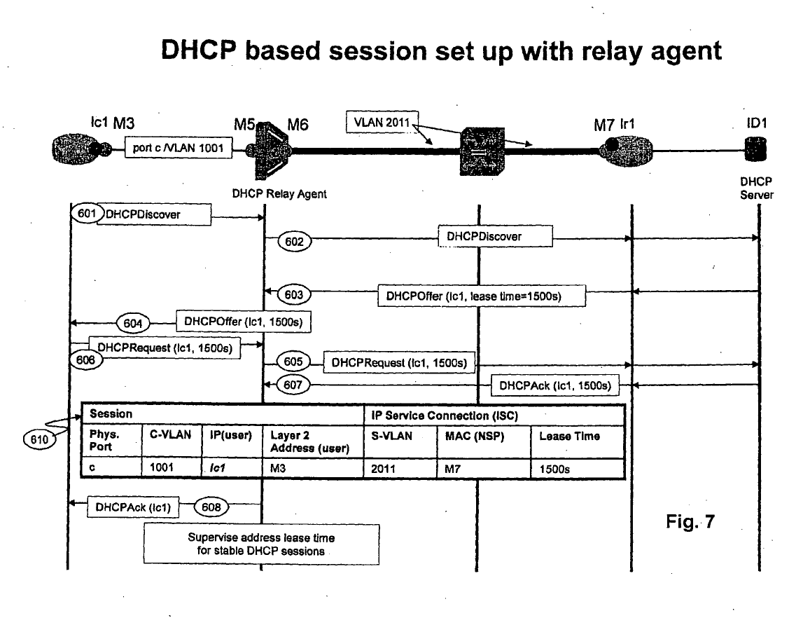

FIG. 7 shows for the case of IPv4 how DHCP messages are used in order to establish an IP session. In this situation a DHCP relay agent, by way of which all DHCP messages between service users and network are routed, is used in the IP service switch. From the message exchange 601 to 608, the relay agent can extract the necessary switching specification and thus fill the table 610. Optionally, the DHCP lease time can be included in the switching specification and be monitored by the IP service switch. The lease time is 1500s long in the example.

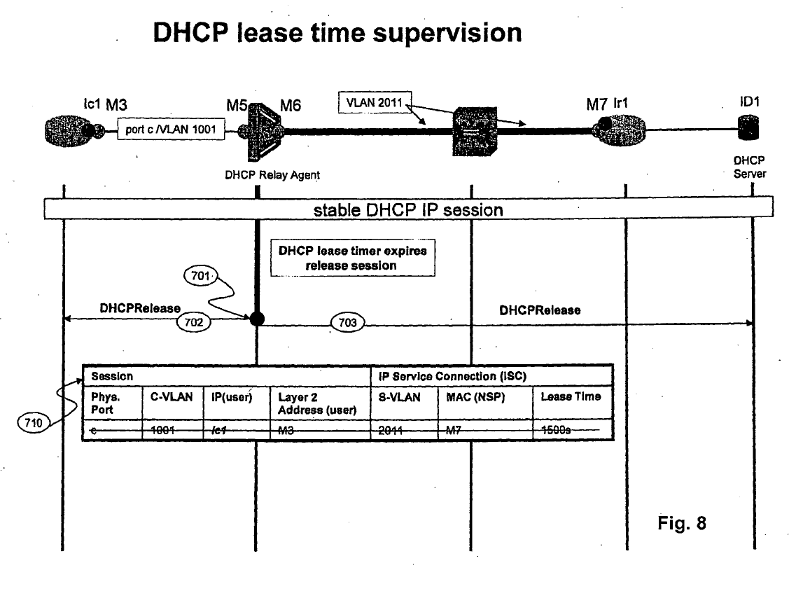

FIG. 8 shows how the IP service switch initiates the IP session after expiry of the lease time. To this end, the relay agent DHCP sends Release messages to the terminal device and to the network-side DHCP server. In addition, the data for the IP session is deleted from the table containing the switching specifications (710). Thereafter, no IP packets with the source address Ic1 are forwarded from this session port into the network.

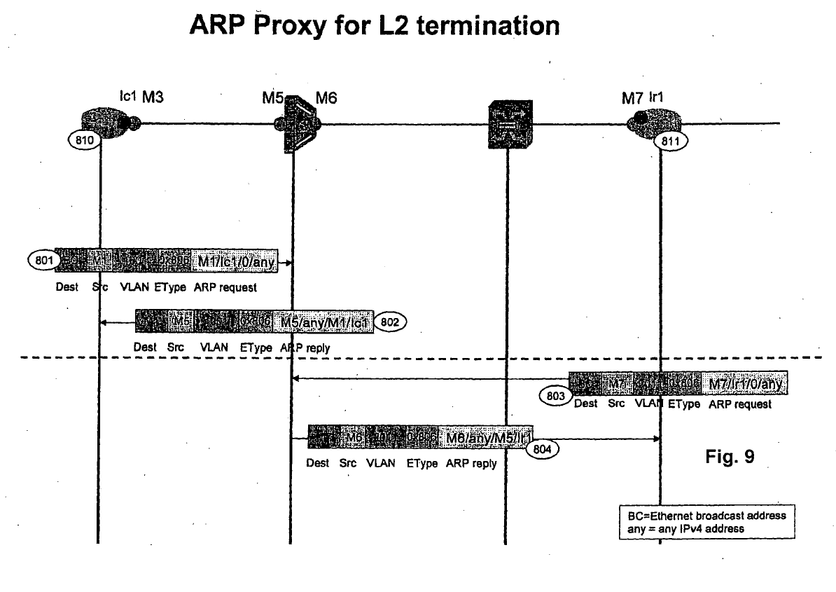

FIG. 9 shows how, in the case of IPv4, ARP requests from the user 801 or ARP requests from the IP edge router 803 are replied to by the IP service switch. In each of the two cases and for each of the “any” IP addresses the IP service switch replies to ARP requests with its respective MAC address. This is M5 in the case of ARP reply 802 and M6 in the case of ARP reply 804. These replies ensure that both the user-side device 810 and also the network-side IP router 811 use the MAC addresses of the IP service switch for sending the IP packets.

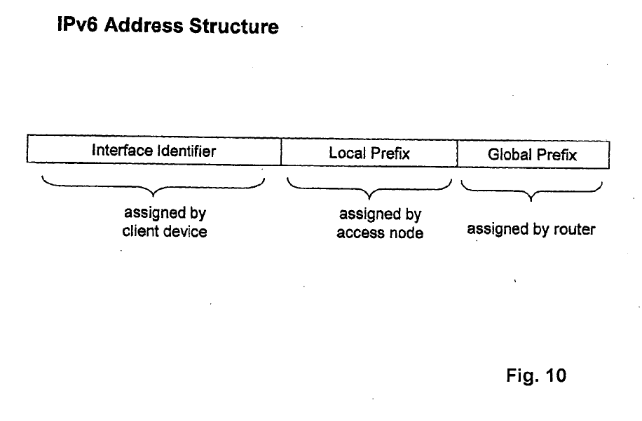

FIG. 10 shows the structure of the IP address for the special case of IPv6. Here the problem arises that the IP address contains an interface identifier which is actually allocated by the client. The interface identifier can match the Layer 2 address of the client but it can also be chosen at random. The problem thus arises that even in the case of identical interface identifiers for a plurality of clients it is necessary to generate a unique IP address. According to the invention, this problem is solved in such a manner that the IP service switch itself is able to allocate a local IP prefix which is chosen such in the individual case that a unique IP address results. It is therefore necessary to assign a plurality of local prefixes to each IP service switch in a subnetwork, such that the combination of local and global prefix always yields a unique IP address, regardless of the respective interface identifier. The client receives this assignment either by way of DHCP or by means of stateless address autoconfiguration (router discovery).

The following advantages can result from the invention:

a) Session-based IP switching instead of IP routing in the IP service switch. This means that the network access provider does not simultaneously need to be the IP network service provider, in other words it does not require any separate IP addresses for the users. At the same time, a plurality of IP network service providers can be supported in the same access network. A user can also simultaneously maintain a plurality of IP sessions with different IP network service providers. The situation is also prevented whereby the number of IP nodes increases by one to two orders of magnitude when compared with IP networks commonly encountered today.

b) The invention makes possible a network architecture for IP/Ethernet-based access networks which shifts the function of the BAS into the access network and modifies it such that the access control can be effected using IP/Ethernet-based methods. On the one hand, this dispenses with the need for a separate BAS, which results in significant cost savings. On the other hand, the access control is shifted closer to the user, resulting in a high level network security and enabling enhanced QoS support.

The termination of Layer 2 can also be an advantage of the invention. Particularly when using Ethernet as Layer 2, a large number of possible attacks on network function and integrity are known. By terminating Layer 2 in the IP service switch, these attacks are largely averted for the network nodes lying behind the IP service switch.

1.-30. (canceled)

31. A method for switching IP packets between a client network and an IP provider network based upon an access network having a network element, comprising:
registering an IP session between the client network and the IP provider network in the network element based upon a first Layer 2 address assigned to the client network and an IP address assigned to the first Layer 2 address;
defining an IP service connection between the network element and an IP provider network in the network element based upon a second Layer 2 address assigned to the IP provider network;
assigning an active IP session to at least one IP service connection or assigning a plurality of active IP sessions to one IP service connection; and
switching the IP packets from active IP sessions to service connections via the network element based upon the assignments in the network element.

32. The method as claimed in claim 31, wherein the IP packets are switched from the service connection to the active IP sessions via the network element based upon the assignments in the network element.

33. A method for switching IP packets between a client network and an IP provider network based upon an access network having a network element, comprising:
registering an IP session between the client network and the IP provider network in the network element based upon a second Layer 2 address assigned to the provider network and an IP address assigned to the second Layer 2 address;
defining an IP service connection between the network element and an client network in the network element based upon a first Layer 2 address assigned to the IP client network;
assigning an active IP session to at least one IP service connection or assigning a plurality of active IP sessions to one IP service connection; and
switching the IP packets from active IP sessions to service connections via the network element based upon the assignments in the network element.

34. The method as claimed in claim 31, wherein the first Layer 2 address or attributes from frames in which IP packets of an IP session are sent to the network element are replaced at least in part with the second Layer 2 address or attributes assigned to the service connection based upon the switching an the assignment in the network element.

35. The method as claimed in claim 31, wherein attributes from frames in which IP packets of an IP session are sent to the network element are replaced at least in part with the attributes assigned to the service connection based upon the switching an the assignment in the network element.

36. The method as claimed in claim 35, wherein the attribute includes a client-side VLAN tag.

37. The method as claimed in claim 31, wherein the Layer 2 address or attributes from frames in which IP packets of an IP service connection are sent to the network element are replaced at least in part with the Layer 2 address or attributes assigned to the IP session based upon the switching an the assignment in the network element.

38. The method as claimed in claim 31, wherein the assignment of an IP session to an IP service connection is learned during a IP session setup by the network element based upon session setup messages.

39. The method as claimed in claim 31, wherein the assignment of an IP session to an IP service connection is changed after session setup based upon a session modification message.

40. The method as claimed in claim 31, wherein all the IP packets of an IP session are switched onto the same IP service connection or IP service connections, regardless of the destination IP address in incoming IP packets of an IP session.

41. The method as claimed in claim 31, wherein the first Layer 2 address is based upon a feature selected from the group consisting of:
an Ethernet MAC address,
a VPI/VCI pair of an ATM path.
a MPLS label of an MPLS path, and
a DLCI of a frame relay path.

42. The method as claimed in claim 31, wherein
the IP session comprises further IP addresses and an attribute selected from the group of:
an Ethernet VLAN tag,
an Ethernet .1p code point of the IP packet to be switched,
a DSCP code point of the IP packet to be switched,
a Layer 2 address of the aforementioned network element,
and combinations thereof.

43. The method as claimed in claim 31, wherein the IP service connection is further comprising an attribute selected from the group of:
an Ethernet VLAN tag,
an Ethernet .1p code point,
a DSCP code point, and
a Layer 2 address of the network element.

44. The method as claimed in claim 31, wherein the IP sessions are set up by IPv6 router discovery/stateless address autoconfiguration messages.

45. The method as claimed in one of claim 31, wherein the network element performs a policy enforcement for an IP session based on information from the session setup messages or the session modification messages.

46. The method as claimed in claim 31, wherein a DHCP lease time is monitored by the network element for the IP sessions and the IP session is shut down on expiry of the lease time.

47. The method as claimed in claim 31, wherein an IPv6 neighbor discovery proxy is implemented in the network element, through which client neighbor discovery requests and network-side neighbor discovery requests are replied to with a Layer 2 address of the network element.

48. The method as claimed in claim 31, wherein a local IP address prefix is assigned to an IP session in addition to the global prefix.

49. A network element of an access network, comprising:
a registration of an IP session between a client network and an IP provider network based upon a first Layer 2 address assigned to the client network and an IP address assigned to the first Layer 2 address,
a definition of an IP service connection between the network element and an IP provider network based upon a second Layer 2 address assigned to the IP provider network,
an assignation of an active IP session to at least one IP service connection or an assignation of a plurality of active IP sessions to the IP service connection, and
a switching of the IP packets from active IP sessions to service connections based upon the assignments.

50. The network element as claimed in claim 49, wherein the first Layer 2 address from frames in which IP packets of an IP session are sent to the network element are replaced at least in part with the second Layer 2 address assigned to the service connection based upon the assignment in the network element.

51. The network element as claimed in claim 49, wherein the Layer 2 address from frames in which IP packets of an IP service connection are sent to the network element are replaced at least in part with the Layer 2 address assigned to the session based upon the assignment in the network element.

52. The network element as claimed in claim 50, wherein
as a result of the assignment the network element replaces attributes from frames, in which IP packets of an IP session are sent to the network element, in their entirety or in part, and wherein as a result of the assignment the network element replaces attributes from frames, in which IP packets of the service connections are sent to the network element, in their entirety or in part.

53. The network element as claimed in claim 50, wherein the network element learns the assignment of an IP session to an IP service connection during the IP session setup based upon the session setup messages.

54. A method for switching IP packets between a client network and an IP provider network via an access network having a network element, comprising:
registering an IP session between a client network and an IP provider network based upon a client-network-side Layer 2 address and an IP address assigned to this client-network-side Layer 2 address;
defining an IP service connection between the network element and an IP provider network based upon a provider-network-side Layer 2 address;
determining the affiliation to an IP session based upon a client network for a received IP packet based upon the client-network-side Layer 2 client address and the IP address assigned to this Layer 2 address;
forwarding the IP packet to the IP provider network via at least one service connection assigned to this IP session;
determining an affiliation to an IP service connection by an IP provider network for a received IP packet based upon the provider-network-side Layer 2 address and the IP address assigned to the provider-network-side Layer 2 address; and
forwarding the IP packet to the client network based upon at least one IP session assigned to this IP service connection.
